(19) United States
(12) Patent Application Publication
(10) Pub. No.: US 2006/0019162 A1
(43) Pub. Date: Jan. 26, 2006

(54) Graphite-base hydrogen storage material and production method thereof

(76) Inventors: Minoru Shirahige, Chiba (JP); Koji Yoneta, Chiba (JP); Junji Katamura, Kanagawa (JP); Mikio Kawai, Kanagawa (JP); Masaharu Hatano, Kanagawa (JP); Masashi Ito, Kanagawa (JP)

Correspondence Address: JOHN S. PRATT, ESQ;KILPATRICK STOCKTON, LLP, 1100 PEACHTREE STREET, ATLANTA, GA, 30309, US

(21) Appl. No.: 11/175,521

(22) Filed: Jul. 5, 2005

(30) Foreign Application Priority Data
Jul. 5, 2004 (JP) P2004-197636

(51) Int. Cl. H01M 4/58; C01B 31/02

(52) U.S. Cl. 429/218.2; 252/182.1; 423/445 R

(57) ABSTRACT

Disclosed is a hydrogen storage material and a production method thereof. The hydrogen storage material has a carbon material having: an interlayer space for hydrogen occlusion, produced by removal at least a portion of an organic compound from a graphite intercalation compound comprising graphite and the organic compound intercalated in the graphite; and an active point at which hydrogen is adsorbed, being produced on the remaining organic compound and/or a part of the hexagonal carbon layers defining the interlayer space. It has a layered lattice structure with hexagonal carbon layers and an expanded interlayer space, and its density determined in accordance with He equilibrium pressure density measuring method changes according as pre-equilibrium He pressures and falls in a range of 0.2 to 1.2 g/cm³ at pre-equilibrium pressures of 0.2 MPa and 0.8 MPa. The hydrogen storage material is produced by; preparing an organic-graphite intercalation compound; and reducing the organic-graphite intercalation compound to remove at least a portion of the inserted organic compound from the organic-graphite intercalation compound, thereby forming an interlayer space.

### BACKGROUND OF THE INVENTION

1. Field of the Invention

The invention relates to a carbon material having a hydrogen storage ability that is prepared using a graphite intercalation compound, and a method for producing the same.

2. Related Art

Fuel cells have attracted peoples notice from the viewpoint of countermeasures for the global green house effect and air pollution, and stabilization and efficiency of energy supply. However, it is important for practically mounting the fuel cell on transport vehicles to investigate a hydrogen storage method, and it has been desired to develop a hydrogen storage material which is cheap and lightweight, having a high hydrogen storage density per volume, and a hydrogen storage method in which the hydrogen may be rapidly filled and discharged with safe and easy handling. Conventional hydrogen storage carbon materials and hydrogen storage methods known in the art comprise, for example, (1) a porous carbon material having a specific surface area of 1500 m²/g and a bulk density of 0.25 g/cm³ or more, which is produced by calcining a carbon material after mixing it with hydrated potassium hydroxide (Japanese Patent Application Laid-Open No. 60-247073); (2) a carbon molecular sieve having a hydrogen storage capacity of larger than 0.0022 g per 1 g of carbon and a volume efficiency of larger than 15 V/V as measured at 790 KPa and 25° C., wherein hydrogen is absorbed in the molecular sieve that is formed by carbonizing a vinylidene chloride copolymer (Japanese Patent Application National Publication (Laid-Open) No. 8-504394); and (3) an activated carbon absorbent having a fine pore structure by polymerization and carbonization after filling interstices of a matrix of a clay mineral with an organic polymerizable precursor (Japanese Patent Application National Publication (Laid-Open) No. 8-506048).

Since the hydrogen absorption mechanism of the activated carbon material depends on exhibiting a hydrogen storage property by absorbing hydrogen into micro-pores of activated carbon, it is necessary for improvement in the amount of adsorbed hydrogen to retain a precious metal on the surface of activated carbon, or to reduce the diameter of fine pores, or to increase the specific surface area. In this relation, Japanese Patent Application Laid-Open No. 10-72201 discloses a porous carbonaceous material retaining a metal having a function for dissociating hydrogen molecules into hydrogen atoms on the surface of the material, wherein examples of the carbon material include activated carbon, fulleren carbon nano-tubes, while examples of the metal include platinum, palladium or a hydrogen storage alloy. On the other hand, Japanese Patent Application Laid-Open No. 2003-171111 specifically discloses a hydrogen storage carbon material having a fine-pore diameter of 0.3 nm or more and 1.5 nm or less with a specific surface area of 50 m²/g or more and 800 m²/g or less and a fine pore volume of 0.01 ml/g or more and 0.3 ml/g. This material is reported to exhibit high hydrogen storage ability in a temperature range of 273 to 373 K. Moreover, Japanese Patent Application Laid-Open No. 2003-225563 specifically discloses a hydrogen storage carbon material having fine pores and a specific surface of 3000 m²/g or more, wherein the fine pore mode diameter is 1 nm or more and 2 nm or less as determined by BJH method.

The conventional carbon materials as described above have attempted to absorb hydrogen into micro-pores, using activated carbon, and they exhibits considerably high hydrogen storage ability, depending on storage and disorption conditions. However, it is a drawback of the conventional carbon material that preparation of materials that can occlude a large amount of hydrogen at ambient temperatures was difficult, and the materials were not suitable for mass-production.

### BRIEF SUMMARY OF THE INVENTION

Accordingly, an object of the present invention is to provide a graphite-base hydrogen storage material having a higher hydrogen storage capacity at room temperatures than the conventional porous materials such as activated carbon, and a simple production method thereof, by effectively utilizing interlayer spaces of graphite for storage of hydrogen.

In order to achieve the above-mentioned object, a hydrogen storage material, according to one aspect of the present invention, comprises a carbon material having: an interlayer space for hydrogen storage, produced by removal of a portion or the whole of an organic compound from a graphite intercalation compound comprising graphite and the organic compound intercalated between hexagonal carbon layers of the graphite; and an active point at which hydrogen is adsorbed, being produced on the remaining organic compound and/or a part of the hexagonal carbon layers defining the interlayer space.

Moreover, according to an aspect of the present invention, a method for producing a hydrogen storage material, according to one aspect of the present invention, comprises: preparing an organic-graphite intercalation compound that is a graphite intercalation compound inserted with an organic compound; and reducing the organic-graphite intercalation compound to remove at least a portion of the inserted organic compound from the organic-graphite intercalation compound and produce a carbon material having an interlayer space.

According to another aspect of the present invention, a hydrogen storage material comprises a carbon material having a layered lattice structure with hexagonal carbon layers, wherein the carbon material has an expanded interlayer space in such a manner that the density with helium equilibrium pressure of the carbon material which is determined in accordance with He equilibrium pressure density measuring method changes according as pre-equilibrium He pressures used in the determination change, and the density with helium equilibrium pressure of the carbon material is in a range of 0.2 to 1.2 g/cm³ when determined by using pre-equilibrium pressures of 0.2 MPa and 0.8 MPa.

### BREIF DESCRIPTION OF THE DRAWINGS

FIGS. 1A and 1B are schematic views for illustrating the method for measuring the density of materials with He equilibrium pressure.

The features and advantages of the hydrogen storage material and the production method according to the present invention over the conventional art will be more clearly understood from the following description of the embodiments of the present invention.

### DETAILED DESCRIPTION OF THE INVENTION

The inventors of the present application have studied to prepare a material useful for hydrogen storage materials taking advantage of carbon materials, and found that a carbon material capable of utilizing interlayer spaces between hexagonal carbon layers for storage of hydrogen molecules can be obtained using as a starting material a graphite intercalation compound that is readily available or produced. While the hydrogen storage carbon material of the present invention has a layered lattice structure resembling to an expanded graphite which is formed by removing the inserted compound from a graphite intercalation compound, the interlayer space of the hexagonal carbon network plane has appropriate dimensions for invasion of hydrogen and it is considerably smaller than the interlayer space of the expanded graphite.

Major elements influencing on the absorption energy for occluding molecules between the layers (between the hexagonal carbon layers) in a layered lattice structure include five elements of London dispersion force interaction, dipolar interaction, hydrogen bonds, electrostatic attraction and covalent bonds. London dispersion force refers to a quite weak attractive force between atoms or molecules by a momentary electric polarization generated when atoms and molecules, or molecules approach each other. While this dispersion force largely reduces when the distance is larger, activated carbon can exhibits a strong absorption power due to its small pore diameter. In other words, a molecule is absorbed in a pore having approximately equal size by a strong dispersion power from the surrounding walls. Accordingly, it may be theoretically elucidated that a space suitable for adsorbing hydrogen can be formed by allowing van der Waals force such as London dispersion force to effectively work when the interlayer space of graphite is uniformly expanded to about 5 to 10 Å. Following this principle, the inventors of the present invention have studied to produce a carbon material having interlayer spaces suitable for invasion of hydrogen, using various graphite intercalation compound, and found that the actual interlayer spaces possibly exhibit a hydrogen absorbing power even when interlayer spaces with an interlayer distance of 60 Å or less are observed with a transmission electron microscope in the layered lattice structure. While spaces with an interlayer distance of more than 60 Å cannot exhibit any absorption power to hydrogen, the structure having spaces irregularly expanded may be provided with the hydrogen absorption power when expanded spaces with an interlayer distance of 60 Å or less are included in the structure.

While the interlayer distance of (002) face in the layered lattice structure of graphite can be usually determined using a 2θ diffraction peak in a powder X-lay diffraction analysis, diffraction peaks cannot be detected when the interlayer distances are irregular as in the above-described carbon material in which the interlayer structure is expanded. It is also difficult to confirm the interlayer distance by the X-lay diffraction method in the carbon material of the present invention, since the interlayer distance is not constant in this carbon material. However, a measurement of a density with an equilibrium pressure of helium (He) can confirm that the carbon material has an interlayer space suitable for invasion of hydrogen, and a carbon material having the hydrogen storage ability can be defined according to this method in the present invention.

The density with He equilibrium pressure is a density that is determined by: supplying helium to a vessel containing a sample and another empty vessel at respective different pressures; determining the volume of the sample from an equilibrium pressure which is measured by connecting the two vessels to make the pressure in the vessels at an equilibrium state; and determining the density with He equilibrium pressure from this volume of the sample and mass of the sample (details of the measuring method will be described below). When the sample volume obtained is different between at high He pressures and at low He pressures, it means that the sample include a space where He does not invade at a lower pressure but invades at a higher pressure. Such a space has a size close to the size of hydrogen molecule, and it may be regarded as a space suitable for invasion of hydrogen. Accordingly, the density with He equilibrium pressure measured at a higher pressure of He is larger than that measured at a lower pressure of He, in the carbon material having spaces suitable for invasion of hydrogen. In a specific example, the carbon material of the present invention having a hydrogen storage ability shows a density D1 of 0.2 to 1.2 g/cm³ in a measurement at pre-equilibrium pressures P₁ and P₂ of 0.2 MPa and 0.8 MPa, respectively, and a density D2, which is measured at pre-equilibrium pressures of 3 MPa and 9 MPa is larger by 0.4 g/cm³ or more than D1. Such a carbon material exhibits good hydrogen storage ability, for example, the hydrogen storage capacity is 1.0% by mass or more in a measurement by a volumetric method using high pressure hydrogen (11.5 MPa). The hydrogen storage capacity under a high hydrogen pressure includes hydrogen invaded by a high pressure and hydrogen adsorbed in the space, and both types of hydrogen are important components for hydrogen storage ability. When the density of the carbon material with He equilibrium pressure is less than 0.2 g/cm³, the material is liable to be broken by the pressure due to its too large bulkiness, and the amount of occluded hydrogen per unit volume actually reduces (probably due to formation of larger spaces by combining plural spaces).

The carbon material having the hydrogen storage ability as described above may be obtained by favorably controlling expansion of interlayer spaces when the inserted compound is removed from a graphite intercalation compound. For practically realizing the method, a graphite intercalation compound prepared by inserting an organic compound, or an organic-graphite intercalation compound, is effectively used as a starting material.

The carbon material of the present invention having a hydrogen storage ability is obtained by reducing an organic-graphite intercalation compound, whose interlayer spaces have been expanded by inserting an organic compound between the layers of a layered structure formed by the hexagonal carbon layers of graphite, in order to remove at least a portion of the organic compound. The hydrogen storage space of the carbon material obtained can be defined either by merely the hexagonal carbon layers having expanded interlayer spaces, or by both of the organic compound remaining between the layers and the hexagonal carbon layers having expanded interlayer spaces. For the organic compound to be inserted, organic molecules having a size capable of being inserted between the layers of graphite are used, and chain compounds and cyclic compounds may be favorably used. Lower-molecular-weight organic compounds, which allow interlayer spaces to be expanded to about 30 Å by inserting the compounds, are preferable. Chain compounds may be classified into linear or branched saturated hydrocarbon (alkanes such as methane), and linear or branched unsaturated hydrocarbon (alkenes such as ethylene and alkins such as acetylene); while cyclic compounds may be classified into cycloalkanes, aromatic monocyclic and polycyclic compounds, condensed cyclic compounds and heterocyclic compounds. Those compounds may have —OR, —Cl, carboxyl group, carbonyl group, amino group and the like as a substituent, and the organic compounds to be inserted can be alternatively classified into halogen compounds, alcohol compounds, carboxyl compounds and carbonyl compounds according to the kind of substituent. Organometallic complexes containing metals and metal soaps may also be used. Preferable examples of the organic compound include unsaturated compounds such as ethylene, isobutene, isoprene, butadiene and acrylonitrile; alkylamines such as octylamine, laurylamine, tetradecylamine, n-hexadecylamine and octadecylamine, and ammonia. Examples of the cyclic compounds include low-molecular-weight organic compounds such as benzene, toluene, styrene, acenaphtylene, tetrahydrofuran, naphthalene and aniline. These organic compounds may be polymerized between the layers when an alkali metal is present there, and such polymerization is allowable.

The hydrogen storage ability of the interlayer space can be improved when a metal is precipitated in the interlayer space, or when active points or functional groups are formed in the interlayer space by activation using steam or an alkali vapor, Examples of available metal include Pt, Pd, Ni, Li, K, Cs, Rb, Ti, Cr, Fe, Cu, Co, Zr, Nb, B and Si, and two or more of these metals may be contained together. The functional group may be given to organic compounds remaining in the interlayer space or on the hexagonal carbon layer, and examples of the functional group include acidic surface functional group such as carboxyl group, phenolic hydroxyl group, carboxylic acid anhydride and lactone; basic surface functional group of chromene and pyrone type structures; and neutral surface functional groups such as carbonyl group, quinone type carbonyl groups and cyclic peroxides.

The method for preparing the carbon material having the hydrogen storage ability will be described below.

The carbon material having the hydrogen storage ability is prepared using an organic-graphite intercalation compound as a starting material. The organic-graphite intercalation compound can be prepared using usual graphite intercalation compounds (inorganic-graphite intercalation compounds). The usual graphite intercalation compound can be classified into graphite oxide and other intercalation compound, and the methods for inserting organic compounds are different therebetween. Examples of the graphite intercalation compound except graphite oxide include metal chloride-graphite intercalation compounds intercalated with a transition metal chloride such as PtCl₄, PdCl₂, NiCl₂, TiCl₄, CrCl₃, FeCl₃, CuCl₂, COCl₂, ZrCl₄, NbCl₅ and the like; chloride-graphite intercalation compounds intercalated with other chloride; fluorine compound-graphite intercalation compounds intercalated with a fluorine compound; alkali metal-graphite intercalation compounds and alkali earth metal-graphite intercalation compounds each of which is intercalated with an alkali metal or an alkali earth metal such as Li, K, Na, Rb, Cs, Ba, Sr and Ca. Ternary or multi-elemental graphite intercalation compounds may also be used, wherein at least two of the metal chlorides described above and other chlorides, fluorine compounds, and alkali metal and alkali earth metal are intercalated. The graphite intercalation compounds having a metal chloride between the layers are advantageous in that the metal of the metal chloride can be used for giving the activated points into the interlayer space.

While the organic compounds readily inserted into the interlay space are smaller molecules having a lower molecular weight or molecules having high affinity to the interlayer space (for example, surfactants), insertion will be easier when a component reactive to the organic molecule (for example, a component arising polymerization reaction) or a component having a lower stability than the organic molecule between the layers is intercalated between the layers.

In a case where an organic-graphite intercalation compound is prepared from graphite oxide, it is difficult to directly insert an organic compound having a lower stability between the layers because the interlayer space is quite narrow. Accordingly, it is essential to insert a cationic surfactant between the layers in advance when an organic compound difficult to intercalate is to be inserted. Since a hydrophobic environment is formed by the presence of the surfactant while the interlayer space is expanded to a certain extent, other organic molecules can be readily inserted. Of course, the intercalated organic compound of the present invention may be composed of only the cationic surfactant. The cationic surfactant used is not particularly restricted, and it is possible to appropriately select one or more to be used, from various surfactants including long chain alkylamines such as n-hexadecylamine and ammonium salts such as n-hexadecyltrialkyl ammonium. The surfactant invades between the layers of graphite oxide by immersing graphite oxide in a solution prepared by dissolving the surfactant in an organic solvent, and by stirring the solution for about 1 day. Thereby interlayer space is expanded to about 25 Å. Organic compounds other than the surfactant are able to invade into the interlayer apace after the surfactant has been inserted by immersing graphite oxide in a solution containing the cationic surfactant and organic compound together. Alternatively, graphite oxide inserted with the surfactant may be immersed in a solution of an organic compound. In some cases, the surfactant invaded into the interlayer space may be replaced with the organic compound in the solution.

In a case where the organic-graphite intercalation compound is prepared from the graphite intercalation compound except graphite oxide, any of the organic compounds described above can be directly inserted according to the effect of intercalated component. In a case where graphite intercalation compound of potassium (K) such as KC₈ and KC₂₄ is used, it is also possible to form a polymer between the layers by inserting polymerizable monomers such as styrene and acrylonitrile with use of THF as a solvent.

The organic-graphite intercalation compound in which an organic compound is inserted is reduced after drying. Practically, the intercalation compound is heated in a non-oxidizing atmosphere, specifically in a reducing gas such as hydrogen gas or in an inert gas such as nitrogen gas. In a case of reduction of graphite oxide, oxygen covalently bonded between the layers of graphite is rapidly decomposed into oxygen gas by calcining at a temperature of 250 to 300° C., and the graphite is vigorously expanded by the rapid gas generation. In contrast, if an organic compound is present between the layers, a weak bond is formed between the covalently bonded oxygen (keto group, enol group) and the organic compound, so that gasifying temperature of such oxygen is expanded in a wide temperature range of 250 to 500° C. If the organic compound is a polymer, decomposition and gasification occur in a further wider temperature range. As a result, decomposition and gasification of oxygen becomes gradual, and interlayer expansion is loosened much in comparison with the case of graphite oxide. Decomposition of the organic compound is also slowly progressed. Although no gasification of oxygen is observed in the organic graphite intercalation compound prepared from the graphite intercalation compound other than graphite oxide, decomposition and removal of the organic compound is mildly progressed by the action of other interlayer substances and hexagonal carbon layers. Accordingly, the interlayer space, from which the organic compound is removed after the interlayer space is expanded by gentle generation of gas, shrinks to a stable distance by intermolecular forces. Since decomposition of the organic compound occurs in a wide temperature range, the proportion for removing the organic compound from the interlayer space can be controlled by adjusting the heating temperature and heating time. A longer heating at a higher temperature results in a high removal ratio. For forming a favorably expanded space, the heating temperature is adjusted to 300° C. or more, preferably 350 to 800° C., and more preferably 400 to 700° C.

If the intercalated inorganic compound presents or the organic compound remains between the layers at the end of the reduction treatment, it functions as a pillar for fixing the layer and the interlayer distance is maintained. If a metal chloride is intercalated, it remains as a metal particle by reduction, resulting in improvement of hydrogen storage ability of the carbon material.

While the interlayer space is expanded in the graphite intercalation compound in which organic compounds are inserted, no space capable of adsorbing hydrogen is formed. Removing a portion or whole of the organic compound allows to form a space in which hydrogen can invade, and decomposition of the organic compound and gas generation at an appropriate speed work to make the space favorable for occluding hydrogen. When the diffraction angle (2^{θ}) of the (002) face is measured by a diffractometer method according to a powder X-ray diffraction method (incident X-ray: CuKα) a diffraction peak at around 26.6°, which corresponds to an interlayer distance of 3.35 Å, is observed in graphite oxide, while the peak appears in a region of 15° or less in the graphite intercalation compound intercalated with an organic compound. Although the peak in the region of 15° or less disappears by removing the organic compound by the reducing treatment and some rise is observed in the region of 4° or less, it is difficult to find peaks showing the space capable of adsorbing hydrogen. This is because the sizes (interlayer distances) of the expanded interlayer spaces are not uniform enough for detecting the space as a peak. However, the space suitable for adsorbing hydrogen can be confirmed by measuring the density with He equilibrium pressure as described above. The method for measuring the density with He equilibrium pressure will be described below.

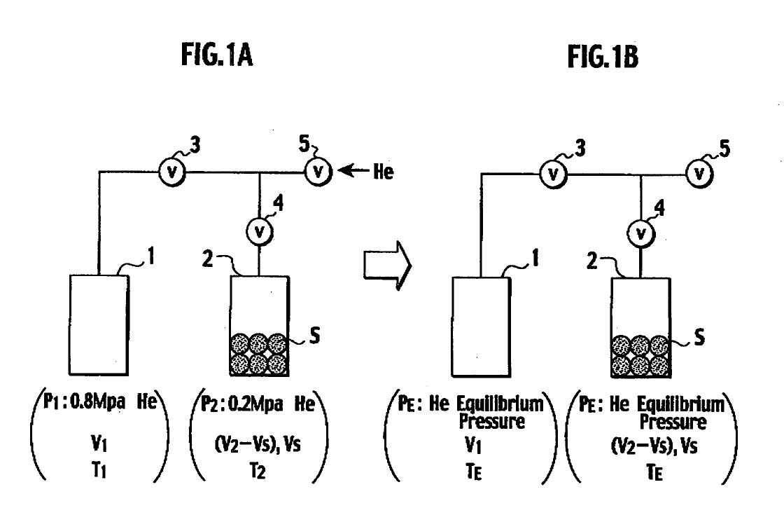

For measuring the density with He equilibrium pressure, a measuring apparatus comprising pressure vessels 1 and 2 is used as illustrated in FIGS. 1A and 1B. Initially, a weighed sample S to be measured is placed in a pressure vessel 2 while pressure vessel 1 is empty, and the pressure vessels 1 and 2 are evacuated. Then, a prescribed amount of He is supplied to the pressure vessel 2 by opening valves 4 and 5 while a valve 3 between the pressure vessels 1 and 2 is closed, and the valve 4 of pressure vessel 2 is closed after accurately measuring the pressure P₂ in the pressure vessel 1. Subsequently, He is supplied to the pressure vessel 1 by opening the valve 3 of the pressure vessel 1, and the valves 3 and 5 are closed after accurately measuring the pressure P₁ in the pressure vessel 1. Thereafter, the pressures in the pressure vessels 1 and 2 are equilibrated by opening the valves 3 and 4, and the equilibrium pressure P_{E} is measured. The volume V_{S} of the sample is calculated using the equation below in accordance with the Boyle-Charles' law, where V₁ and V₂ denote the volumes of the pressure vessels 1 and 2, respectively, P₁, P₂ and P_{E} denote the pressures obtained by the measurement, T₁ and T₂ denote the temperatures in the pressure vessels 1 and 2, and T_{E} denotes the temperature at equilibrium of the pressure. The density with the equilibrium pressure is obtained by calculating W/V_{S} from the mass W and volume V_{S} of the sample.
[(P₁·V₁)/T₁]+[P₂·(V₂−V_{S})/T₂]=[(P_{E}·V₁)/T_{E}]+[P_{E}·(V₂−V_{S})/T_{E}]

When the sample has spaces suitable for invasion of hydrogen (a space having a size close to the size of the hydrogen molecule), He cannot invade the space if pressure P₂ for measuring the density with equilibrium pressure and P_{E} (i.e. the pressures applied on the sample) are low. Accordingly, the volume of the sample obtained from the measurement includes the volume of interlayer spaces, and the density obtained is a bulk density which is smaller than true density. On the contrary, if the pressure P₂ and P_{E} for measuring the density with equilibrium pressure are high, the density of the sample obtained by the measurement becomes close to the true density, since He is pressed into the space. In other words, the density with equilibrium pressure obtained varies depending on the pressure at the measurement. Such changes of the density with equilibrium pressure are not observed when the size of the spaces in the sample is large, since He can readily invade the space. Accordingly, the larger changes of the density with equilibrium pressure depending on the measuring pressure are indicative of a larger volume of the space suitable for invasion of hydrogen. The carbon material of the present invention having hydrogen storage ability shows variations of the density with He equilibrium pressure ascribed to the measuring pressure, and, as described above, the density D1 with He equilibrium pressure in the measurement at P₁ and P₂ of 0.2 MPa and 0.8 MPa is in the range of 0.2 to 1.2 g/cm³.

### EXAMPLES

Organic-graphite intercalation compounds were prepared using graphite oxide or graphite intercalation compounds prepared from graphite as described below. Samples of carbon materials were prepared from the organic-graphite intercalation compound, and their properties were measured to detect hydrogen storage ability.

1. Preparation of Graphite Oxide and Graphite Intercalation Compound

(Sample Nos. 1 to 4)

Into 150 ml of fuming nitric acid, 8 g of natural graphite (flake graphite with an average particle diameter of 8 μm) was added, and the mixture was allowed to react at 55° C. for 3 hours by adding 64 g of potassium chlorate. The mixture after the reaction was diluted with water, and the product was filtered and dried to prepare graphite oxide.

(Sample Nos. 5 to 7)

After calcining natural graphite (flake graphite with an average particle diameter of 300 μm) at 300° C. for 24 hours, a 5 g portion of the product was weighed in a glove box. Potassium (0.7 g) was mixed with it, and the mixture was placed in a glass-made two-bulb tube, which was evacuated for 4 hours while maintaining the temperature at 60° C. The content was sealed from air by fusing the 2-bulb tube. The content in the tube was kept at 300° C. for 3 days to prepare a graphite intercalation compound (KC₂₄).

(Sample No. 8)

SOCl₂ as a solvent (25 ml) was poured into a vessel placed in a glove box. After calcining natural graphite (scaly graphite with an average diameter of 300 μm) at 300° C. for 24 hours, 1.5 g of the calcined graphite was weighed in the glove box. Moreover, 1.56 g of H₂PtCl₆/6H₂O was weighed, and this chemical and calcined graphite was added to SOCl₂ in the vessel. The SOCl₂ solution in the vessel was stirred while allowing argon to flow in the glove box, and a graphite intercalation compound was produced by refluxing the solvent at 95° C. The reaction solution was diluted with THF, the graphite intercalation compound was filtered off, washed with THF and dried to obtain the graphite intercalation compound (PtCl₄-GIC). Insertion of THF in this graphite intercalation compound was confirmed by TG-mass spectrum analysis.

2. Insertion of Organic Compound

(Sample No. 2)

After adding 2 g of graphite oxide in n-hexane, 8 g of n-hexadecylamine was added as a surfactant with stirring for 1 day. Graphite oxide in which n-hexadecylamine was inserted was obtained by filtering the solution, followed by drying the product. This product was added to a solution prepared by dissolving styrene in n-hexane, and the mixture was allowed to react with stirring. The solution was filtered, and the filtered matter was dried to obtained 10.3 g of graphite oxide in which styrene was inserted.

(Sample Nos. 3 and 4)

After adding 2 g of graphite in n-hexane, 8 g of n-hexadecylamine was added as a surfactant with stirring for 1 day. Filtration and drying of this solution afforded graphite oxide in which n-hexadecylamine was inserted. The product was added to a solution prepared by dissolving polyaniline in n-methylpyrrolidone. After allowing the mixture to react with stirring, the solution was filtered, and the filtered matter was dried to obtain 10.2 g of graphite oxide in which polyaniline was inserted.

(Sample Nos. 5 and 6)

A solution composed of THF and styrene mixed in a proportion (weight ratio) of 4:1 was prepared, and 2 g of a potassium-graphite intercalation compound (KC₂₄) was added to the solution. After allowing the mixture to react with stirring for 1 day, the solution was filtered, and the filtered matter was dried to obtain 8.6 g of the graphite intercalation compound (KC₂₄) in which styrene is inserted.

(Sample No. 7)

A solution composed of THF and acrylonitrile mixed in a proportion (weight ratio) of 4:1 was prepared, and 2 g of a potassium-graphite intercalation compound (KC₂₄) was added to the solution. After allowing the mixture to react with stirring for 1 day, the solution was filtered, and the filtered matter was dried to obtain 2.8 g of the graphite intercalation compound (KC₂₄) in which acrylonitrile is inserted.

3. Reduction Treatment

(Sample No. 1)

Graphite oxide was heated for 60 minutes while the temperature was raised to 400° C. in hydrogen atmosphere.

(Sample No. 2)

Graphite oxide in which styrene was inserted was heated for 60 minutes while the temperature was raised to 700° C. in hydrogen atmosphere.

(Sample No. 3)

Graphite oxide in which polyaniline was inserted was heated for 60 minutes while the temperature was raised to 600° C. in nitrogen atmosphere.

(Sample No. 4)

Graphite oxide in which polyaniline was inserted was heated for 60 minutes while the temperature was raised to 400° C. in nitrogen atmosphere.

(Sample No. 5)

A graphite intercalation compound (KC₂₄) in which styrene was inserted was heated for 60 minutes while the temperature was raised to 300° C. in hydrogen atmosphere.

(Sample No. 6)

A graphite intercalation compound (KC₂₄) in which styrene was inserted was heated for 60 minutes while the temperature was raised to 700° C. in hydrogen atmosphere.

(Sample No. 7)

A graphite intercalation compound (KC₂₄) in which acrylonitrile was inserted was heated for 60 minutes while the temperature was raised to 700° C. in nitrogen atmosphere.

(Sample No. 8)

A graphite intercalation compound in which THF was inserted (PtCl₄-GIC) was heated for 60 minutes while the temperature was raised to 350° C. in hydrogen atmosphere.

4. Activation Treatment

(Sample No. 4)

The carbon material after the reducing treatment and KOH were mixed in a proportion of 11:4 (mass ratio), and the mixture was calcined at 700° C. for 1 hour in argon atmosphere.

5. Measurement of Properties of Samples

Carbon materials in Sample Nos. 1 to 8 were evaluated from the following measurements. The results of evaluation of Sample Nos. 1 to 4 are shown in Table 1, while the results of evaluations of Sample Nos. 5 to 8 are shown in Table 2.

(Powder X-ray Diffraction: XRD)

A 2^{θ} peak pattern was obtained from powder X-ray diffraction measurement of each sample, using an automatic recording X-ray diffractometer (trade name: MXP 18V AHF, manufactured by Mac Science) equipped with a counter tube. For the measurement, the applied voltage and current to the X-ray tube were 40 kV and 150 mA, and ChKα was used as the incident X-ray. Denotations A, B, C and D for 2^{θ} in Tables 1 and 2 show a very large peak, a substantially large peak, a small peak and a slightly observed peak, respectively.

(Observation Under Transmission Electron Microscope)

A fine structure of each sample was observed using a transmission electron microscope (trade name; Tecnai G2, manufactured by EFI Inc.) at an acceleration voltage of 200 kV.

(Measurement of the Density with He Equilibrium Pressure)

The density with equilibrium pressure was determined by placing a sample in a pressure vessel 2 in accordance with the method for measuring the density with He equilibrium pressure as described previously using the apparatus in FIGS. 1A and 1B. The pressure (P₁) of He applied on the pressure vessel 1 was 0.8 MPa, the pressure (P₂) of He applied on the pressure vessel 2 was 0.2 MPa, and each temperatures T₁, T₂ and T_{E} for measuring respective pressures was 30° C. The density with equilibrium pressure was determined in the sample in Sample No. 6 from the measurement at (P₁, P₂)=(3 MPa, 9 MPa) and (P₁, P₂) (5 MPa, 10 MPa).

(Measurement of the Hydrogen Storage Ability)

Each sample was precisely weighed according to the test methods in Japanese Industrial standard Nos. 7201 and 7203. After evacuating a test tube containing the sample, hydrogen was supplied at a pressure of 11.5 MPa, and the hydrogen storage ability (% by mass) was measured. Then, the hydrogen desorption ability was confirmed by reducing the hydrogen pressure to an atmospheric pressure.

TABLE 1

| | | Sample 1 | Sample 2 | Sample 3 | Sample 4 |
|---|---|---|---|---|---|
| Organic- | Starting material | graphite | graphite | graphite | graphite |
| graphite | | oxide | oxide | oxide | oxide |
| inter- | Organic | — | n-hexadecyl- | n-hexadecyl- | n-hexadocyl- |
| calation | compound | | amine, | amine, | amine, |
| compound | intercalated | | styrene | polyaniline | polyaniline |
| | XRD 2 θ peaks | 13.36: A | 3.44: B | 2.96: A | 2.96: A |
| | mainly detected | 26.64: D | 4.18: A | 5.86: B | 5.86: B |
| | in a range of 27 | | 26.52: D | | |
| | degrees or less | | | | |
| | Density with He | 2.20 g/cm³ | 0.97 g/cm³ | 1.05 g/cm³ | 1.05 g/cm³ |
| | equilibrium pres. | | | | |
| | H₂ storage | 0 mass % | 0 mass % | 0.05 mass % | 0.05 mass % |
| | ability | | | | |
| Carbon | Reducing atm. | H₂ | H₂ | N₂ | N₂ |
| material | Reducing temp. | 400° C. | 700° C. | 600° C. | 400° C. |
| provided | Activation | — | — | — | Alkali |
| with | material | | | | compound |
| interlayer | XRD 2 θ peaks | rise at ≦4: A | rise at ≦4: A | rise at ≦4: A | rise at ≦4: A |
| space | mainly detected | 19.9: A | 21.10: B | 26.10: A | 20.10: B |
| | in a range of 27 | 26.36: B | 26.32: A | | 26.10: A |
| | degrees or less | | | | |
| | Density with He | 1.41 g/cm³ | 0.29 g/cm³ | 0.21 g/cm³ | 0.82 g/cm³ |
| | equilibrium pres. | | | | |
| | H₂ storage | 0.05 mass % | 1.84 mass % | 3.10 mass % | 1.50 mass % |
| | ability | | | | |
| | at 11.5 MPa | | | | |

According to Table 1, a peak is observed at 13.36° and no peak is observed at around 2^{θ}=26.6° as a diffraction peak of the (002) face of graphite, since interlayer spaces in graphite oxide as a starting material in Sample No. 1 are almost uniformly oxidized. On the contrary, peaks are observed at around 3° and 5° in the graphite intercalation compounds as the starting materials in Sample Nos. 2 to 4, and show that the interlayer space is expanded by insertion of organic compounds (n-hexadecylamine, styrene and polyaniline).

In Sample No, 1, the peak at 13.36° disappears after the reducing treatment, and a base rise is observed at an angle of 4° or less. Since oxygen in graphite oxide starts to be decomposed at 250 to 300° C., oxygen in the interlayer space is decomposed and eliminated by the reducing treatment at 400° C. in Comparative Example 1. Consequently, the interlayer space shrinks to shift the 2^{θ} peak to a higher angle, while the interlayer space tends to inflate against shrinkage of the space due to rapid gas generation. As a result, the interlayer space is broken and graphite oxide changes to fine particles to make it difficult to maintain spaces inside the material particles. Therefore, the density of the carbon material with He equilibrium pressure after the reducing treatment is 1.41 g/cm³, which is not so decreased from 2.2 g/cm³ as the corresponding density of graphite oxide. The hydrogen storage ability at a pressure of 11.5 MPa is as small as 0.05% by mass.

In the graphite oxide in which an organic compound is inserted (Sample Nos. 2 to 4), diffraction peaks at around 3° and 5° disappear by the reducing treatment while an area at an angle of 4° or less is raised. No peaks corresponding to expanded interlayer space are found. However, this is because the interlayer spaces were irregularly expanded and a regular layer structure was lost. The presence of the expanded interlayer space is recognized by the density with He equilibrium pressure. For example, it is clear that spaces appropriate for hydrogen occlusion have been formed since the densities at an equilibrium pressure of He after the reducing treatment are as small as 0.29 g/cm³ (Sample No. 2) and 0.21 g/cm³ (Sample No. 3), while the hydrogen storage abilities are largely increased to 1.84% by mass (Sample No. 2) and 3.10% by mass (Sample No. 3).

The temperature for the reducing treatment is set at a lower temperature (400° C.) in Sample No. 4 than the temperatures (700° C. and 600° C.) in Sample Nos. 2 and 3, in order to permit a portion of the organic compound inserted between the layers to remain between the layer, and the sample has been activated with an alkali after the reducing treatment. Since the density with He equilibrium pressure is larger in Sample No. 4 than in Sample Nos. 2 and 3, it is suggested the volume of the interlayer space is small with the remaining intercalated organic compound. Since the carbon material in Sample No. 4 shows a hydrogen storage ability close to the hydrogen storage ability in Sample No. 2 despite the high density with equilibrium pressure, the activation treatment is considered to be effective. It may be supposed that, after the reducing treatment, the functional group is added on the organic compound remaining in the interlayer space or on the layer wall (hexagonal carbon network plane) as an active point.

Although it is difficult to detect the XRD diffraction peaks corresponding to the expanded interlayer spaces in the carbon material after the reducing treatment, disappearance of peaks showing the starting material's own interlayer distance in the region with 2^{θ} of 15° or less, and rise in the region with 2^{θ} of 40 or less represent that the carbon material is subjected to the reducing treatment. A decrease in the density with helium equilibrium pressure shows that the interlayer space is expanded. It can be confirmed by measuring the hydrogen storage ability, as well as by the variation of the density with He equilibrium pressure depending on the measuring pressure, that the expanded interlayer space is suitable for storage of hydrogen.

TABLE 2

| | | Sample 5 | Sample 6 | Sample 7 | Sample 8 |
|---|---|---|---|---|---|
| Organic- | Staring material | KC₂₄ | KC₂₄ | KC₂₄ | PtCl₄-GIC |
| graphite | Organic | THF | THF | THF | THF |
| inter- | compound | styrene | styrene | acrylonitrile | |
| calation | intercalated | | | | |
| compound | XRD 2 θ peaks | 3.7: C | 3.7: C | 3.8: C | 3.8: C |
| | mainly detected | 19.2: C | 24.6: B | 25.68: B | 26.6: A |
| | In a range of 27 | 24.6: B | 26.5: A | 26.6: A | |
| | degrees or less | 26.5: A | | | |
| | Density with He | 1.39 g/cm³ | 1.39 g/cm³ | 1.40 g/cm³ | 1.75 g/cm³ |
| | equilibrium pres. | | | | |
| | H₂ storage | 0 mass % | 0 mass % | 0.04 mass % | 0.05 mass % |
| | ability | | | | |
| Carbon | Reducing atm. | H₂ | H₂ | N₂ | H₂ |
| material | Reducing temp. | 300° C. | 700° C. | 700° C. | 350° C. |
| provided | Activation | — | — | — | — |
| with | material | | | | |
| interlayer | XRD 2 θ peaks | rise at ≦4: C | rise at ≦4: B | rise at ≦4: B | rise at ≦4: C |
| apace | mainly detected | 19.2: D | 26.50: A | 24.22: C | 26.60: B |
| | In a range of 27 | 26.56: A | | 26.50: A | |
| | degrees or less | | | | |
| | Density with He | 1.25 g/cm³ | 0.245 g/cm³ | 0.235 g/cm³ | 0.550 g/cm³ |
| | equilibrium pres. | | | | |
| | H₂ storage | 0.15 mass % | 2.62 mass % | 2.07 mass % | 3.20 mass % |
| | ability | | | | |
| | at 11.5 MPa | | | | |

The materials in Sample Nos. 5 to 8 were prepared by inserting organic compounds into graphite intercalation compounds intercalated with metals. The peak at an XRD diffraction angle 2^{θ} of 3.7 or 3.8° is considered to show the interlayer space expanded by inserting an organic compound (THF or styrene (Sample Nos. 5 and 6), THF or acrylonitrile (Sample No. 7), and THF (Sample No. 8)). Since these peaks disappear in all the samples after the reducing treatment with accompanied rise in the region of 4° or less, the interlayer space is irregularly expanded. However, when the temperature for the reducing treatment is relatively low, for example in Sample No. 5 (300° C.) and Sample No. 8 (350° C.), the rise is small in the region at 4° or less, and the organic compound seems to remain between the layers without being completely removed. This may be comprehended from the fact that the decrease in density with He equilibrium pressure by the reducing treatment is relatively small. Accordingly, the sample of the carbon material in Sample No. 5 has a relatively small volume of spaces for hydrogen storage to result in a small hydrogen storage ability. On the contrary, a high ratio of the organic compound is removed in Sample Nos. 6 and 7, and a large volume of spaces suitable for hydrogen storage is formed. Consequently, the density with He equilibrium pressure is small to result in a high hydrogen storage ability.

Sample No. 8 largely differs from Comparative Sample No. 5 in that the metal between the graphite layers is in the form of a metal chloride, not an alkali metal. While the metal is eliminated from the interlayer space by the reducing treatment when the metal is the alkali metal, the metal chloride precipitates as a metal in the interlayer space or on the hexagonal carbon layer by applying the reducing treatment, thereby enhancing the hydrogen occluding ability. Consequently, the hydrogen storage ability is quite as large as 3.20% by mass, although the density with He equilibrium pressure is relatively large and the volume of the space for hydrogen storage is not so large.

The densities with He equilibrium pressure were measured at (P₁, P₂)=(3 MPa, 9 MPa) and (5 MPa, 10 MPa), respectively, using the sample of the carbon material in Sample No. 6 as an example. The results shows that the density with equilibrium pressure was 0.968 g/cm³ at (P₁, P₂)=(3 MPa, 9 MPa), and the density wiht the equilibrium pressure was 1,138 g/cm³ at (P₁, P₂)=(5 MPa, 10 MPa). The results show that the higher the He pressure is the more the density with equilibrium pressure increases, or the higher the He pressure is the more the volume induced from the volume decreases. This means that the amount of He invading the interlayer space increases as the He pressure increases, or that there is a space having a similar size to the size of He molecule, or a space suitable for adsorbing the hydrogen molecule having a size close to the size of the He molecule.

It must be understood that the invention is in no way limited to the above embodiments and that many changes may be brought about therein without departing from the scope of the invention as defined by the appended claims.

What is claimed is:

1. A hydrogen storage material comprising a carbon material having: an interlayer space for hydrogen storage, produced by removal of a portion or the whole of an organic compound from a graphite intercalation compound comprising graphite and the organic compound intercalated between hexagonal carbon layers of the graphite; and an active point at which hydrogen is adsorbed, being produced on the remaining organic compound and/or a part of the hexagonal carbon layers defining the interlayer space.

2. The hydrogen storage material of claim 1, wherein the remaining organic compound of the carbon material includes chain compounds and cyclic compounds.

3. The hydrogen storage material of claim 1, wherein a powder X-ray diffraction analysis of the graphite intercalation compound shows a diffraction peak in a range of 2^{θ} being 15 degrees or less, a powder X-ray diffraction analysis of the carbon material shows that the diffraction peak in the range of 2^{θ} being 15 degrees or less is lost and the base in a range of 2^{θ} being 4 degrees or less is raised.

4. The hydrogen storage material of claim 1, wherein the carbon material has a density with helium equilibrium pressure, that is in a range of 0.2 to 1.2 g/cm³ when determined using pre-equilibrium pressures of 0.2 MPa and 0.8 MPa in accordance with He equilibrium pressure density measuring method.

5. The hydrogen storage material of claim 1, further comprising an element which is selected from the group consisting of Pt, Pd, Ni, Li, K, Cs, Rb, Ti, Cr, Fe, Cu, Co, Zr, Nb, B and Si, being provided on the interlayer space or the hexagonal carbon layers defining the interlayer space.

6. A method for producing a hydrogen storage material, comprising:
preparing an organic-graphite intercalation compound that is a graphite intercalation compound inserted with an organic compound; and
reducing the organic-graphite intercalation compound to remove at least a portion of the inserted organic compound from the organic-graphite intercalation compound and produce a carbon material having an interlayer space.

7. The production method of claim 6, wherein the reducing comprises:
heating the organic-graphite intercalation compound in a non-oxidizing atmosphere.

8. The production method of claim 7, wherein the temperature of heating the organic-graphite intercalation compound is 350 to 800 degrees C.

9. The production method of claim 6, wherein the preparing of the organic-graphite intercalation compound comprises:
inserting an organic compound into an inorganic-graphite intercalation compound, wherein the inorganic-graphite intercalation compound is selected from the group consisting of graphite oxide, metal chloride-graphite intercalation compounds, chloride-graphite intercalation, fluorine compound-graphite intercalation compounds, alkali metal-graphite intercalation compounds, alkali earth metal-graphite intercalation compounds and ternary graphite intercalation compounds.

10. The production method of claim 9, wherein the inorganic-graphite intercalation compound shows a diffraction peak in a range of 2θ being 15 degrees or less in a powder X-lay diffraction analysis, and the reducing of the organic-graphite intercalation compound is performed in such a manner that, in a powder X-ray diffraction analysis of the produced carbon material, the diffraction peak in the range of 2θ being 15 degrees or less is lost and the base in a range of 2θ being 4 degrees or less is raised.

11. The production method of claim 6, further comprising, after the reducing:
activating the produced carbon material to form on the produced carbon material an active point at which hydrogen is adsorbed.

12. The production method of claim 6, wherein the organic compound includes chain compounds and cyclic compounds.

13. The production method of claim 6, wherein the organic compound is selected from the group consisting of linear or branched saturated hydrocarbons, linear or branched unsaturated hydrocarbons, cycloalkanes, aromatic monocyclic and polycyclic compounds, condensed cyclic compounds and heterocyclic compounds.

14. The production method of claim 6, wherein the organic compound includes ethylene, isobutene, isoprene, butadiene, acrylonitrile, octylamine, laurylamine, tetradecylamine, n-hexadecylamine, octadecylamine, benzene, toluene, styrene, acenaphtylene, tetrahydrofuran, naphthalene and aniline.

15. The production method of claim 9, wherein the metal chloride-graphite intercalation compound contains a transition metal chloride which is selected from the group consisting of PtCl₄, PdCl₂, NiCl₂, TiCl₄, CrCl₃, FeCl₃, CUCl₂, CoCl₂, ZrCl₄ and NbCl₅, the alkali metal-graphite intercalation compound contains an alkali metal which is selected from the group consisting of Li, Na and K, and the alkali earth metal-graphite intercalation compound contains an alkali earth metal which is selected from the group consisting of Rb, Cs, Ba, Sr and Ca.

16. The production method of claim 9, wherein the inorganic-graphite intercalation compound includes graphite oxide, and the preparing of the organic-graphite intercalation compound further comprises:
inserting a cationic surfactant into graphite oxide.

17. A hydrogen storage material comprising a carbon material having a layered lattice structure with hexagonal carbon layers, wherein the carbon material has an expanded interlayer space in such a manner that the density with helium equilibrium pressure of the carbon material which is determined in accordance with He equilibrium pressure density measuring method changes according as pre-equilibrium He pressures used in the determination change, and the density with helium equilibrium pressure of the carbon material is in a range of 0.2 to 1.2 g/cm³ when determined by using pre-equilibrium pressures of 0.2 MPa and 0.8 MPa.

18. The hydrogen storage material of claim 17, wherein the density with helium equilibrium pressure of the carbon material when determined by using pre-equilibrium pressures of 3 MPa and 9 MPa is higher by 0.4 g/cm³ or more than the density with helium equilibrium pressure determined by using pre-equilibrium pressures of 0.2 MPa and 0.8 MPa.
